(19) United States
(12) Patent Application Publication
(10) Pub. No.: US 2004/0217847 A1
(43) Pub. Date: Nov. 4, 2004

(54) Wireless sensing system

(76) Inventors: Robert G. Fries, Colorado Springs, CO (US); Monti Wilkins, Streamwood, IL (US); Anthony Menolascino, Elmhurst, IL (US)

Correspondence Address: CHARLES C. VALAUSKAS, BANIAK PINE & GANNON, 150 N. Wacker Drive, Suite 1200, Chicago, IL, 60201, US

(21) Appl. No.: 10/766,089

(22) Filed: Jan. 26, 2004

Related U.S. Application Data
(60) Provisional application No. 60/442,375, filed on Jan. 24, 2003.

(51) Int. Cl. H04Q 7/00; G08B 5/22

(52) U.S. Cl. 340/7.21; 340/539.1

(57) ABSTRACT

A two-way wireless security system network includes a security system including condition sensors. The security system generates a first signal type according to a first signal protocol in response to a condition detected by the sensors. A two-way wireless communication subsystem is in communication with the system and includes a microprocessor for converting the first signal into standard over-the-air wireless protocol. A wireless interface unit transmits a second signal type corresponding to the standard over-the-air wireless protocol to a wireless communications carrier service and receives over-the-air data from the communications carrier service, convertible to instructions and conveyable to the security system. A computing device communicates with the wireless communications carrier service and includes a database table for converting the second signal type into a predefined signal format usable by a monitoring company and includes a conveyance device for conveying the predefined signal format to the identified monitoring company.

This application claims the benefit of Provisional application No. 60/442,375 filed Jan. 24, 2003.

### FIELD OF THE PRESENT INVENTION

The present invention generally relates to security systems that monitor conditions within a defined environment or area. In particular, the present invention is a security system that employs wireless communications and which is operable without the use of hard-wired or land lines such as telephone lines or the like to convey signals between the monitored premises and the other off-premises elements of the system.

### BACKGROUND OF THE INVENTION

Electronic security systems are becoming more common and important in residential and commercial environments. Individuals and families, in particular, desire a security system that monitors a defined premise and/or environment, to prevent or deter theft, burglary and robbery. In addition, there is a desire to monitor and detect other defined conditions and, in response to a detected condition, generate a warning. These other potentially hazardous conditions or threats include, for example, fire hazards, carbon monoxide and power failure and electricity outages.

A conventional security system for use in a home, for example, includes a keypad and a (possibly separate) central control panel. A number of sensors, for detecting various conditions are arranged in the home or premises and are connected to the control panel by wired or wireless means. The sensors may be of various types designed to detect a variety of conditions. The keypad allows a user to control the system. The user can use the keypad to “arm” or “disarm” the system in addition to selecting amongst the sensors to control. In the event of a false alarm, the homeowner may use the keypad to reset the alarm. The typical control panel includes a central microprocessor or an equivalent, which receives messages from the sensors including, for example, motion sensors, infrared sensors, magnetic or glass break sensors, fire sensors and carbon monoxide sensors. If the system is “armed” and one or more sensor is triggered, a signal is generated and received by the control panel. The control panel circuitry activates a built-in telephone communicator to contact the proper authority, for example law enforcement, firefighting and/or health professionals, and conveys, for example, a pre-recorded message providing relevant information related to the triggered sensor. Alternatively, the telephone communicator may contact a security company monitoring the system, for example ADT, and provide information about the event which triggered the alarm condition. The security company, in turn, relays the information to the proper authority.

Each home may have zones each of which include an appropriate sensor. The signal generated by the security system may contain information indicating in which zone the sensor has been triggered. The security monitoring company requires a database which identifies what part of the premises the triggered zone corresponds to. The security monitoring company necessarily has a unique set of database entries for each home.

In such a conventional security system, the built in telephone communicator uses a typical hard-wired telephone line to send and receive signals to and from the security system to various authorities and/or monitoring companies. A disadvantage of this type of a system becomes clear in the event a telephone line is interrupted or fails, for example by cutting or malfunction, whereby signals from the security system control panel can not be transmitted or received. Other methods of compromising the telephone lines are known without the need to damage the telephone line since many phone companies provide an accessible service port on the exterior of the building. As an attempt to bolster the reliability of the alarm reporting mechanism, the security industry introduced the wireless (typically cellular-based) backup system.

However, such systems have drawbacks. -In operation, the security system will often not recognize when a phone line has been disabled until an alarm condition occurs and the system attempts to report the alarm via the phone line. Many seconds may pass before the system determines that the phone line is disabled and then executes an attempt to send a message by way of the backup system. During that period, an intruder may be able to locate and disable the security system.

Although a few systems exist today that use wireless reporting as the primary means, they typically only provide capability to report alarms to a central monitoring facility and do not include a means to simultaneously inform the user of the alarm. Additionally, such systems typically only report alarm conditions and do not report non-emergency conditions. As a result, if a user is away from the secured premises for an extended period, and a condition occurs that does not invoke an alarm report, the user will be unaware of such condition until returning to the premises.

Additionally, although some security systems do allow for a measure of remote control capability such as arming and disarming of the system, doing so requires the use of a hard-wired telephone line. Due to the lack of ease of use of such features in today's security systems, most security system installation companies do not even inform the user about such capabilities, as training the user is time consuming and expensive and is likely to continue to be an ongoing support issue. As a result, capabilities for remote control of the system go unused, even though they may be very useful to the user. What is needed in the industry is a convenient means for a user to remotely control his security system.

Many alarm monitoring service providers charge the subscriber based on the number of monitored sensors. Hence if a user wishes to be notified on non-emergency conditions such as a defective backup battery in the security system, he will need to pay the alarm monitoring company an extra amount to provide that service for him, if it is even available at all. What is needed in the industry is a cost-effective means for a user to be notified of non-emergency conditions at the monitored space.

In the case of business facilities, if the business owner operates several different facilities he will likely need to give out alarm disarming and arming codes to personnel since he may be unable to physically get to each facility in a timely manner at opening or closing. In these cases he runs the risk of a dishonest employee being able to enter the facility at any time, disable the security system, and take away company property. If the owner were able to arm or disarm the security system remotely, then the owner would not need to reveal the security system codes; thus, even if an employee had a key to the facilities, he would not be able to enter without the owner's knowledge without tripping the alarm. What is needed in the industry is a convenient means for a business owner to remotely arm and/or disarm the security system at a facility.

The current methods of provisioning a new system at an alarm monitoring service provider require that the security system installer provide a detailed list of descriptions corresponding to each sensor that is assigned to a unique ‘zone’. Such a method is laborious and error-prone not only on the initial installation, but also creates a need to duplicate work if the installed system needs to be upgraded by adding or changing sensors or their zone assignments. What is needed in the industry is an automated method of reporting zone descriptions that does not require customized zone description lists for each installed security system.

There are very few security systems on the market which are capable of keeping the premises owner informed about the condition of the premises, let alone informing them in an automated fashion when alarms occur. If a condition occurred that prevented an assigned alarm monitoring service from responding to an alarm condition that occurred, the owner would have no knowledge that such condition occurred and would not be able to take an alternate course to correct the problem. What is needed in the industry is a convenient means to notify facility owners of the status of their facilities.

Current security systems rarely even have the capability to monitor and/or report the ambient temperature of the monitored space. As such, winter conditions in particular present a danger to facilities due to freeze-up of water pipes. What is needed in the industry is a means to measure ambient temperature, preferably inside a wall of the facility rather than in open rooms, as the inner wall temperature is more representative of what water pipes will see.

In another case, computer server rooms are often not monitored for temperature at all. If air-conditioning equipment were to malfunction, there is a strong possibility not only of data loss but of permanent damage to equipment as temperatures inside the computer servers reach critical levels. Such rooms often need security monitoring as well, to protect confidential data. What is needed in the industry is a convenient means to be notified if the temperature of a monitored space exceeds a critical threshold, preferably such threshold being adjustable through a convenient means.

What is needed in the industry is a convenient means for a user to be notified of both emergency and non-emergency conditions at the monitored space. What is further needed in the industry is an effective and more tamper-resistant mechanism and method of conveying alarm conditions occurring at a monitored facility to an alarm monitoring service provider. A demand therefore exists for a system and method that reduces or eliminates landline-based communication failures and addresses the above disadvantages. The present invention satisfies the demand.

### SUMMARY OF THE INVENTION

The present invention includes a security monitoring system including various sensors, positioned within a facility, building or home to be monitored in combination with an interface to a 2-way wireless communication system for transporting sensed conditions as messages to and from the monitored facility.

In one embodiment the interface includes a separate interface unit, security monitoring system and a separate 2-way communication system. In another embodiment, the invention includes a standard or customized security monitoring system capable of directly communicating with a standard or customized 2-way wireless communication system in the native communication protocol of the 2-way wireless communication system. In another embodiment, the invention includes a standard or customized 2-way wireless communication system capable of directly communicating with a standard or customized security monitoring system in the native communication protocol of the security monitoring system.

The invention conveys event, and/or status, and/or control messages to and/or from the security monitoring system and/or other on-premises apparatus, with a 2-way communication system. The messages may contain a plurality of information rather than a single event and/or status and/or. control indication.

The invention utilizes encoding techniques for reducing the quantity of data conveyed by means of the 2-way wireless communication system. The invention may utilize encryption techniques for enhancement of the security of the data being conveyed by the 2-way wireless communication system. The invention further includes a method of selectively conveying and optionally translating messages from the security system, to an alarm monitoring service provider. The provider receives the message in a format appropriate for their use, optionally with the aid of one or more computer server employed at one or more stages during the conveyance of the message.

The invention may further include a method and device for selectively conveying and optionally translating messages from the security system, to one or more users, by a variety of communication devices in a plain language format, optionally with the aid of one or more computer server being employed at one or more stages during the conveyance of the message. The invention may further include a method and device for accepting control input from one or more users through a communication device, like a telephone, and translating the input into an appropriate format and conveying the formatted input to the security monitoring system or other apparatus at the monitored premises by the 2-way wireless communication system, optionally with the aid of one or more computer server being employed at one or more stages during the conveyance of the message.

The invention may include the presence or use of a hard-wired connection to the monitored premises. Such may indeed optionally be present and may function as a backup for some or all of the 2-way wireless communication system messages and/or for conveying separate information from that conveyed by the 2-way wireless communication system.

The invention may optionally includes a wireless communication subsystem including a battery and the 2-way communication system and any other apparatus necessary for generating messages to be transmitted and/or received through the use of the 2-way communication system and operating in a stand-alone manner. The subsystem is capable of using the battery to provide operating power for the subsystem, such that if the subsystem were disconnected from an external power source and/or could no longer communicate with the security monitoring system, the subsystem would be capable of generating and transmitting a related status message while operating in the stand-alone mode.

The invention optionally includes a subsystem including an enclosure, a compact antenna, the 2-way communication system, a battery, and any other devices for generating messages to be transmitted and/or received through the use of the 2-way communication system and operating in a stand-alone manner. The subsystem would be more resistant to attempts to tamper with or disable the subsystem due to the restriction of access to vulnerable elements of the subsystem afforded by enclosing the vulnerable elements in a manner suitable for restricting access thereto.

An aspect of the invention is to provide a security system that is not dependant on a telephone line. To this end, the system includes an interface unit which transmits and receives wireless signals to permit communication between the security system and a remote party. In this manner, the security system is able to transmit alerts and status signals to a remote party or location without relying on a conventional wired phone system, and is also able to receive instructions from a remote party or location for the security system.

Another aspect of the invention includes voice activation or touch activation, or both, to provide information to an individual, a system, or central monitoring device by using a wireless primary reporting link. Another aspect of the invention includes controlling the security system off-site or off the premises where the security system is located. The invention may include a portable communication device, such as a pager, that can be easily carried by the user. The portable communication device can notify the user of triggers such as a latchkey disarming or fire by calling and leaving a clear, concise voice or text message. The user can remotely arm or disarm the security system and/or control other features of the security system.

Another aspect of the invention includes the ability to optionally control and/or monitor other sensors and devices through the use of the wireless link, where the devices are not a typical element of the connected security system. Such sensors and/or devices may include, for example, temperature sensors, lamps, appliances, thermostats and other devices or sensors.

Another aspect of the invention includes an antenna that is contained entirely within the enclosure of the wireless communication module, rendering it difficult to defeat due to its concealed nature. Another aspect of the invention includes optional use of an external, remotely located directional antenna that is less susceptible to jamming attacks due to the inherent ability of such an antenna to reject jamming signals originating from outside the directional antenna's lobes of sensitivity.

Further, the invention optionally includes circuitry and/or software that allows for adapting the wireless communication interface to existing security systems to alleviate the need to purchase an entire new system. The wireless communication interface can connect to a variety of electronic equipment via flexible generic software and hardware interfaces.

Furthermore, the invention provides for the reporting of telephone line problems for those systems providing information based on a system that uses a telephone line. The invention provides for the reporting of power loss at the security system by the wireless communication interface, whether or not the security system itself is capable of detecting and/or reporting any such power loss. The wireless communication interface is adapted to monitor itself for malfunctions such as loss of communication with the security system or other hardware or software problems, and to report these problems.

These, together with other aspects and advantages will be further understood in the details of the construction and operation of the invention as more fully hereinafter described, reference being had to the accompanying drawings, forming a part hereof, wherein like numerals refer to like part throughout.

### BRIEF DESCRIPTION OF DRAWINGS

FIG. 1 is a wireless security network including a wireless security system according to the present invention; and

FIG. 2 is a security system and wireless communication interface according to the present invention.

### DESCRIPTION OF PREFERRED EMBODIMENTS

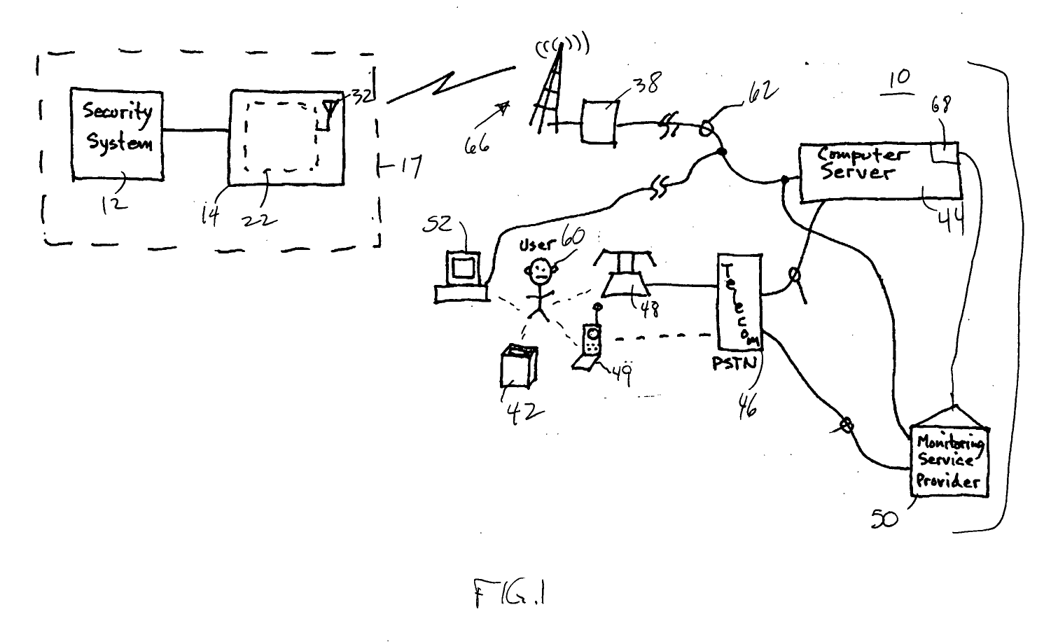

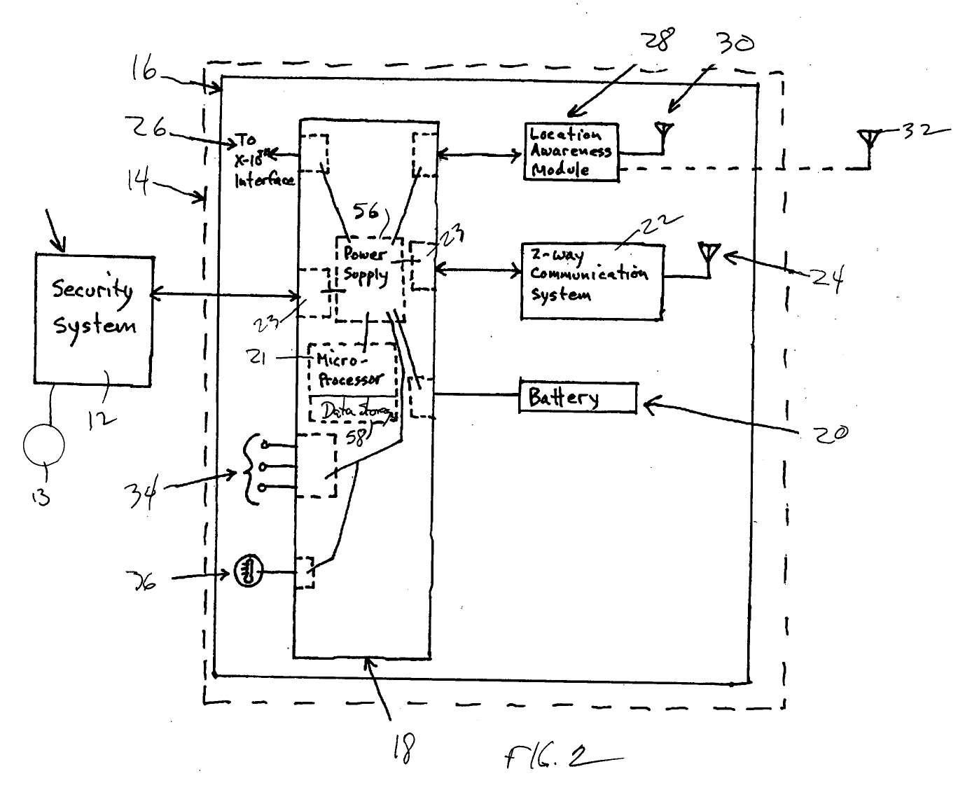

FIGS. 1 and 2 show a wireless security network 10 according to the present invention. The wireless security network 10 in broad overview includes a conventional security system 12 in communication with a monitoring service provider 50 through a wireless enabled network 66 such as SkyTel Telemetry Services or ARCH, for example. The wireless communication between a security system 12 and a security monitoring company 50 is effected by aspects of a wireless communication subsystem 14 having a 2-way wireless communication system 22.

The present invention relates to a system and method for control of a security system. The security system network 10 uses a wireless 2-way system or module 22 as the primary mechanism to report alarm, trouble, status and system messages, for example, but also to remotely and wirelessly control the security system 12 (arm, disarm) and any auxiliary circuits.

The security system 12 is installed in a facility 17, such as a home or commercial building or the like, to be monitored with conventional condition sensors 13 and provided with other equipment, such as necessary power backup systems (not shown) and so on as is practiced in the field.

The invention includes a security system network, shown generally at 10, including a standard security panel 12, such as a standard GE Simon model of security panel, including the capability of detecting defined conditions with standard sensors (13, FIG. 2) and generating a signal responsive to the condition. Examples of these conditions and messages include alarm trip (with zone identifiers), power failure (AC), total power loss of AC and system, backup battery malfunction, low backup battery alert, wakeup message, status request reply, duress alarm, tamper warning, supervisory warnings, RF jam attempt, latchkey alerts, and so on.

The invention includes a subsystem 14 capable of wireless communication with an outside entity including a security operations center 50. The subsystem is positioned within an enclosure 16. An interface unit 18 is positioned within the enclosure 16. The interface unit 18 includes a microprocessor-based computing device 21 and standard connectors 23 to enable one or both of power conveyance and signal communication with the security monitoring system 12 and communication with the 2-way wireless communication system 22. The interface unit 18 includes a rechargeable battery 20, a 2-way wireless communication system 22 provided with a compact antenna 24. The subsystem 14 optionally includes an interface 26 to an external X-10™ powerline communication module.

The subsystem 14 optionally includes a location-awareness module 28 (GPS or equivalent) with either an internal antenna 30 or connections to an external antenna 32 or both for redundancy. The subsystem 14 also optionally includes a plurality of configurable electrical signal lines 34 which may be configured through operating software of the interface unit 14 operatively associated with the microprocessor 21. The configurable electrical signal lines 34 may be connected to the monitoring system 12 and various ancillary equipment (not shown), such as electric relays for controlling external devices, or electrical input signals possibly not related to security functions, or for interfacing with utility measuring equipment such as gas, water or electric meters, or tamper sensors for the subsystem 14 itself. The subsystem 14 also optionally includes a temperature sensor 36 to allow monitoring of the ambient temperature of the premises to detect and report overtemperature conditions in computer server rooms, or undertemperature conditions in a home such as may present an early warning of water pipe freeze-up due to heating system failure. The enclosure 16 is preferably constructed of a material or in a manner which will not impact the operation of the 2-way wireless communication system 22 while also preventing tampering.

The microprocessor 21 allows the interface unit 18 to be configured to accommodate the protocol used to communicate with the specific type of connected security monitoring system 12. The microprocessor 21 also allows the interface unit 18 to be configured to accommodate the protocol used to communicate with the specific type of connected 2-way wireless communication system 22.

The interface unit 18 includes a power supply system 56 capable of adapting an externally supplied power source for use by the elements of the wireless subsystem 14. In the preferred embodiment, the external power source is provided by the connected security monitoring system 12. The interface unit 18 includes configurable interfacing and power supply circuitry 23 to allow interfacing to one of a variety of 2-way wireless communication systems 22 which each may require different electrical signaling input and/or different operating power requirements. To this end, the interface unit 14 includes a computing device 21, which allows the interface unit to be configured to accommodate the protocol used to communicate with the specific type of connected 2-way communication system 22. The computing device 21 allows the interface unit to be configured to accommodate an optional encoding and/or decoding method when constructing or deconstructing messages (commonly referred to as an over-the-air protocol) conveyed by the use of the 2-way communication system 22.

The interface unit 14 optionally includes circuitry 34 for interfacing to an external X-10™ powerline communication system (not shown). X-10 is a communications “language” that allows compatible products to talk to each other using the existing electrical wiring in the home. Most X-10 compatible products are very affordable and the fact that they talk over existing wires in the home means that no costly rewiring is necessary. Installation is simple, a transmitter plugs (or wires) in at one location in the home and sends its control signal (on, off, dim, bright, etc.) to a receiver which plugs (or wires) into another location in the home. These products add the convenience of a radio frequency link (e.g. signals which travel through the air) to X-10 products. Popular products in this class include wireless hand-held remote controls and wireless motion detectors. A plug-in unit with an antenna is required to catch the radio signal from the wireless unit and puts the X-10 signal onto the line Oust like a garage door remote activates the opener).

The computing device 21 allows the interface unit to be optionally configured to accommodate the protocol used to communicate with an X-10™ powerline communication system 26. In a preferred embodiment the X-10™ interface 8 is not provided due to similar functionality being available as an optional feature of the preferred variety of security monitoring system 12.

The interface unit 14 optionally includes circuitry for interfacing to a internal location-awareness system 28, which may include either an internal antenna 30 and/or connection for an external antenna 30. The interface unit 14 includes a computing device 21, which allows the interface unit to be optionally configured to accommodate the protocol used to communicate with the specific type of connected location-awareness system 28. In the preferred embodiment, a GPS receiver is optionally employed as the location-awareness system 28.

The interface unit 14 optionally includes a temperature sensor 36 for measuring the ambient temperature of the subsystem 14. The computing device 21 allows the interface unit 14 to be configured to measure and optionally report the reading of the temperature sensor 36. The computing device 21 is configurable to automatically generate low temperature and/or high temperature warning messages which are transmitted by use of the 2-way wireless communication system 22. The interface unit 14 optionally includes a configurable interface to unspecified electrical signal inputs and/or outputs 34. The computing device 21 allows the electrical input/output signal interface 34 to be configured, controlled and/or measured by the computing device 21 in response to messages sent and/or received by the 2-way wireless communication system 22.

The interface unit 14 may include a data storage device 58 for storing information including software downloads for updating the software of the computing device 21. The computing device 21 allows the data storage device 58 to be written and read by means of the microprocessor 21 with information received from a local data connection or from data received by means of the 2-way wireless communication system 22. The computing device 21 is optionally further capable of reconfiguring itself using the information present in the data storage device 58. Information held in the storage device 58 is also optionally encrypted using standard encryption methods.

The preferred embodiment of the invention further includes a wireless communications carrier service infrastructure 66, an internet-based message conveyance 52 (a computer), a paging message conveyance 42 (a pager), one or more computer server 44, one or more telephony interface 46 for use by the computer server 44, a land line telephone 48 or cellular phone 49, and an alarm monitoring and response service 50.

Operatively associated and connected to the security system 12 is an interface unit 18 capable of a variety of novel functions and, in general, is responsible for the wireless transmission and reception of signals between the security system 12 and the monitoring service provider 50 as well as a user 60 as will be explained more fully below. The interface unit 18 connects to a wireless data transceiver 22 that transmits and receives data and resides in the location 17 to be monitored.

The 2-way wireless communication system 22 may be a “CreataLink XT” manufactured by SmartSynch Corp., a California Barran module from Advantra International (Belgium) or an OmniData module from Percomm Inc. Canada. The interface unit 14 may also be configured to receive messages from cellular, GPRS, packet radio and other 2-way sources.

One example of operation of a preferred embodiment of the invention is described as follows. The security system 12 detects an alarm or non-alarm event and conveys this to the interface unit 14, or the interface unit 14 will detect an alarm or non-alarm event from a source other than the security system 12. The interface unit 14 decides if the event is to be transmitted using the 2-way wireless communication system 22, and if so, will generate a message in a standard format and pass it to the 2-way system 22 along with the address of the desired server 44. The 2-way wireless communication system 22 will transmit the message to the wireless carrier's infrastructure system 66, which will then forward the message to the server 44 as designated by the ‘address’ in the wirelessly-transmitted message. The server 44 will in turn decode the message and determine whether to report it to one, both or neither of the users 60 and the alarm monitoring service 50, and will also keep an internal log of the message and if, necessary will react internally to the message contents (as happens for certain types of maintenance messages). The server 44 can use a variety of methods to convey messages to the user(s) 60 and/or the alarm monitoring service 50, including, for example, internet-based messages, telephony-based alarm and including Contact-ID messages or paging messages.

Another example of operation of the preferred embodiment is described as follows. The user will use telephony device 49 to contact the computer server 44 though telephony interface 46. The server 44 may optionally identify the specific user by use of ANI (Automatic Number Identification, commonly referred to as Caller-ID™), or may request the caller to identify themselves through some other identifier. The server 44 will then collect a command from the user 60, generate an appropriately formatted message to convey the command, and forward this to the wireless carrier's infrastructure system 66 along with a designator to identify the specific destination 2-way wireless system 14. The carrier 38 will transmit the message, which is then received by the 2-way wireless system 22 at the premises 17. The interface unit 18 will detect the incoming message, receive it from the 2-way wireless system 22, decode it, and decide what action needs to be taken. If the message is intended to control the security system 12, such as requesting it to arm itself, the interface unit 18 will translate and transfer the message as necessary into the protocol of the security monitoring system 50. If the message was a request to control one of the ‘spare’ input/output electrical signals 34 then the interface unit 18 would take such action. If the message was a request for specific information from the system 12, the interface unit 18 would collect such information as necessary, format it for transmission, and pass it to the 2-way system 18. The message would eventually reach the user 60 through the same steps previously described.

In operation, in yet another example of a forward path event, the security system 12 registers information from the sensors 13. For example, if a window has been broken, sensor 13 generates a signal which is detected by the security system 12. The security system 12 conveys a message to the interface unit 18. The interface unit 18 examines the message and reformats it into a standardized format (described in more detail below) as necessary to be conveyed wirelessly, and conveys the result to the transceiver (22). This message is transmitted from the 2-way wireless communication system 22 via antenna 24 to a wireless enabled network (SkyTel) 66. The wireless enabled network 66 receives the message which is forwarded via a communications infrastructure 38 and 62 to a computer server 44. The computer server 44 interprets the message and reformats it into a format which can be analyzed by a monitoring service provider 50. The monitoring service provider 50 analyzes the message and takes appropriate action. In the alternate, and dependent upon the nature of the signal and options set up by the user 60, the signal may be routed to the user via telephone 48, cell phone 49, pager 42 or computer 52, for example via conventional routing devices, such as an communication or internet router 44 or PSTN 46.

In operation, in yet another example of a reverse path event, a control signal may be generated by a user 60 or the monitoring service provider 50 and transmitted by wireless enabled network 66 to the wireless communication subsystem 14, processed and a system control function effected such as, for example the system turning on a kitchen light in the residence 17 or disarming the security system 12, as will be explained more fully below.

It will be understood that the invention, in order to be compatible with any security system 12 as a “front end” and using a 2-way communications module 22 to convey messages to and from the security system monitoring company 50 through the wireless network 66 preferably uses a standard over-the-air wireless protocol (OTAP). To this end, signals from the security system 12 are converted from the system 12. The Simon® available from GE Interlogix keeps descriptions internally. These signals are of 2 bytes, which are subdivided into 4 separate fields. These are retrieved by the interface unit 18, and translated via tables (not shown) into the 3 bytes used in the 10-byte OTAP. An Ademco security module 12 sends bit-patterns for display on the LCD. In this case, the LCD patterns are gathered and converted via table to ASCII, then multiple ASCII characters are collected together into words, then a table is searched to convert this data into the 10-byte OTAP (See Table 1).

TABLE 1
STANDARD ZONE NUMBER ASSIGNMENTS FOR ALL ACCOUNTS
The following assumes the use of Contact-ID messaging.
ZONE DESCRIPTION
NUMBER OF SENSOR

| | |
|---|---|
| 000 | System |
| 001 | User #1 |
| 002 | User #2 |
| 003 | User #3 |
| 004 | User #4 |
| 005 | User #5 |
| 006 | Dealer |
| 007 | Installer |
| 008 | Master User |
| 009 | Duress |
| 010 | North Front Door |
| 011 | North Back Door |
| 012 | North Side Door |
| 013 | North Garage Door |
| 014 | North Upstairs Door |
| 015 | North Downstairs Door |
| 016 | North Basement Door |
| 017 | North Attic Door |
| 018 | North Hallway Door |
| 019 | North Bedroom Door |
| 01B | North Closet Door |
| 01C | North Medicine Cabinet Door |
| 01D | North Outside Door |
| 01E | North 2nd Garage Door |
| 01F | North Master Bedroom Door |
| 020 | North Guest Room Door |
| 021 | North Child's Room Door |
| 022 | North Utility Room Door |
| 023 | North Living Room Door |
| 024 | North Dining Room Door |
| 025 | North Bathroom Door |
| 026 | North Laundry Room Door |
| 027 | North Kitchen Door |
| 028 | North Porch Door |
| 029 | North Patio Door |
| 02B | North Office Door |
| 02C | North Den Door |

The converted data is conveyed through the wireless network 66 to a server 44. The server 44 receives the 10-byte OTA protocol messages, along with an identifier indicating the unique source. A database table is used to convert from the Skytel ‘pin’ number (such as 1531019) not the set of user information (such as name, address, phone number, email address, etc.). The message is decoded using a visual basic program which has access to a set of database tables. It will be understood that other methods could easily be used. In order to convert to a Contact-ID format usable by a particular security monitoring company 50, tables are used to convert the contents of the descriptor bytes into the three separate digits available as the zone number in the Contact-ID protocol. The actual choices of what zone numbers get what descriptors are not critical. Other pieces of the Contact-ID message are either fixed-content or are derived from the sensor status byte or a monitoring account number attached to that particular user/Skytel PIN number. Specific formatting is added and the phone number that needs to be dialed, and the completed message is sent to a serial port of the server 44, where it is sent out to the monitoring company 50 via a dial-up phone line.

Table 1 is a partial, incomplete example of the types of descriptors and it will be understood that the actual table will be longer to include all of the various specific sensor sites possible within a monitored site. The above table is loaded into a database at the monitoring company 50, and is usable for all customers regardless of the security system 12 protocol and the protocol used by the monitoring company. This saves the work of manually entering customized zone assignment lists for each individual customer, and also eliminates the need for a system installer to keep track of what sensor is on what zone at the house 17. The descriptions are used alone, and the particular zone number is not critical to operation of the system.

When an alarm or other condition is detected and reported by the security system, the interface unit gathers the zone description information from the security system 12. This will vary from one alarm panel to the next. For GE, the zone descriptions are held inside the unit; the alarm report indicates a zone number, then the interface unit looks up the description for that zone number in a database inside the alarm panel (in other words, the security system does not inherently provide the description; it must be obtained). For Ademco, the description is intercepted from that which is sent to the LCD display on the user 60 alarm control panel. Other systems may not have any descriptor information; in which case, the zone number is forwarded as in the prior art. Once the description is in some form, it is translated into the Over-The-Air ten-byte protocol. This includes 10 bytes with the following meanings:

Byte 1: type of system & protocol (example: 0×7E=GE Simon®, sent using ASCII rather than binary data)

Byte 2: revision # of the wireless interface module (in case it is necessary to make a change later that makes the rest of the message contents incompatible with the initial system, whereas it is possible to process the remainder of this message differently as required).

Byte 3: Zone Number (as reported by the security system). This information is used in certain cases currently, such as to identify which user key fob is being used to arm or disarm the system. It is not normally used when reporting alarm conditions to the monitoring company 50.

Byte 4: Source location/direction. This is part of the ‘zone description’ information. This byte contains data like front, back, downstairs, utility Room, garage, etc.

Byte 5: Qualifiers. Part of the ‘zone description’ information. This byte contains data like north, south, east, west, floor, and ceiling, open, close.

Byte 6: Event Source Descriptor. Identifies what ‘type’ of sensor is reporting, e.g., door, window, smoke, fire, tamper, AC power failure, temperature alarm, etc.

Byte 7: SENSOR status. This includes information about that specific sensor being reported, e.g., alarm trigger, low battery, supervisory alert, cancel alarm (like when smoke clears from a smoke sensor), tamper alarm, and others.

Byte 8: SYSTEM status. This indicates overall status of the security system, e.g., armed/disarmed, triggered, low-temperature warning, high-temperature warning, phone line broken (if available).

Byte 9: Current temperature of the module. This is provided as a feature to help prevent water pipe freeze-ups as one example. The interface unit 18 may be installed inside a wall where the security system 12 is mounted, to make it harder to disable it. Another application would be if this were part of a security system for a computer server room, the unit 18 could alternately be used as a HIGH-temperature alarm indicator simply by changing the trip temperature, which can be changed through the wireless connection.

Byte 10: Software revision # of the connected security system 12. This would be useful in case certain features are not available in older/newer versions of a particular security system model; if the main server 44 has data regarding which software version of the security system 12 is installed, the unit 18 can avoid requesting things of the panel that the security system 12 cannot do, or alternately a different way of accomplishing the same thing might be enacted.

Note that the above constitutes the messaging from the unit 18 to the server 44. In the reverse direction, a different protocol is used.

Byte 1: Indicates what type of alarm panel this message is intended for. For Simon®, use ‘˜’. In case an interface unit 18 connected to an Ademco panel gets this message, it will ignore it.

Byte 2: Command Code. For example, ‘A’ means ARM the system, ‘L’=control the lights, ‘D’=DISARM the system, ‘P’=program an option flag (that changes other behaviors of the module, such as enabling it to report all ARM and DISARM actions by users, or NOT reporting any arm/disarm actions.

Byte 3-10: The rest of the bytes are parameters to go along with the Command Code.

In order to generate a plain-text message (opposed to a Contact ID message) the email address is used provided for that particular user 60, and using different tables from the various bytes of the OTAP message are converted into English-language equivalents; for instance, converting “11A@” into “Front North Door Alarm trigger”. The output from the server 44 is handled by a conveyance device, also known in one embodiment, as a contact ID box 68. This contact ID box 68 contains a microcontroller with a serial port (UART & RS232 converter), as well as an analog-to-digital converter (ADC), as well as a pulse-width-modulation (PWM) peripheral (not shown). It also has circuitry for connecting to a phone line (transformer, relay, etc.) (not shown). The UART receives the messages from the server 44, and stores them. Software then splits the message up into its various pieces and verifies the completeness of the received message. If the phone line is not already in use by the contact ID box 68, it closes the relay to essentially ‘pick up’ the line (go off-hook). Using the ADC and digital signal processing (DSP) algorithms, the processor listens for dial tone, then generates DTMF signals (by use of the PWM peripheral) to ‘dial’ the phone number that was received from the server 44.

Using the ADC & DSP, the processor ‘listens’ for busy signal, ring tones or Contact-ID answer tones. After detecting the answer tones, the processor then generates DTMF signals which directly correlate to the Contact-ID message contents. When the receiver at the monitoring company 50 has fully received the message, an acknowledgement tone is sent back, then a hang up is executed. When the processor in the contact ID box 68 receives the tone, it also hangs up the line. The box 68 holds onto the message until it is able to get it all the way through to the monitoring company, including hanging up and redialing if needed. There are also provisions for redundancy by having multiple Contact-ID processor boards interconnected and able to monitor each other's condition and take over if one board fails.

Alternate embodiments may include the ability for one or more users 60 to send commands to the computer server 44 by way of SMS messaging, Smartphone™ internet browsers, email messages, 2-way pager messages or other currently available devices to the user(s), for the commands to be optionally translated and further forwarded to the premises 17 by means of the 2-way communication system 22.

Alternate embodiments may eliminate one use of the computer server 44 in the preferred embodiment by providing for one or more users 60 to send appropriately formatted command messages, through the use of standard communications devices available to the user(s), which may include internet messaging, paging, emails or other standard devices available to the user(s), directly to the premises' 2-way communication system 22.

Alternate embodiments may include alternate devices for 2-way wireless communications, including satellite, cellular, paging, telemetry, Low Earth Orbit, GPRS, Broadband, 802.XXX networks, packet data radio, and any other system capable of communicating 2-way data.

Alternate embodiments may include devices for connecting the interfaced 2-way communication system 22 subsystem 14 to a security monitoring system 50 by short-range wireless 2-way communications, including ZIGBEE™, Bluetooth™ or other proprietary or open wireless communication methods, rather than using a wired connection between the subsystem 14 and the security monitoring system 50.

Alternate embodiments may include a plurality of security monitoring systems 50, possibly interconnected through a network, rather than being limited to a single security monitoring system 50.

Alternate embodiments may eliminate one use of the computer server 44 in a preferred embodiment by sending appropriately formatted wireless messages directly from the 2-way communication system 22 to an alarm monitoring service means 50 which is capable of receiving messages which may include internet messaging or other systems available to be used from the 2-way communication system 22.

Alternate embodiments may eliminate one use of the computer server 44 in the preferred embodiment by sending appropriately formatted wireless messages directly from the 2-way communication system means 22 to the communications devices (42, 48, 49, 52) of one or more users 60 through, for example, internet messaging, paging, emails or other means available to be used from the 2-way communication system 22.

Alternate embodiments of the invention may include the interface unit 18 providing destination indicators which include addresses other than or in addition to the computer server 44, such as email addresses of users 60, cell-phone email addresses, SMS messaging addresses, pager addresses, addresses monitored by the alarm monitoring and response services means, or others, thereby potentially eliminating the need for a computer server 44.

In an alternate embodiment of the invention, the 2-way wireless communication system 22 and the associated RF communications carrier 66 may convey messages in one of a plurality of formats, including email messaging, internet messaging, TCP/IP messaging, SMS messaging, packet radio protocols, paging protocols or others. In an alternate embodiment of the invention, any communicating element of the system may convey messages in an encrypted manner.

Thus, while the invention has been described with respect to certain preferred embodiments, it will be understood by those of skill in the art that there are modifications, substitutions and other changes that can be made, yet will still fall within the intended scope of the invention, as set forth in the following claims.

What is claimed is:

1. A two-way wireless security system network comprising:
a security system including one or more sensors, said security system generating a first signal type according to a first signal protocol in response to a condition detected by said one or more sensors;
a two-way wireless communication subsystem including a microprocessor for converting said first signal type into a standard over-the-air wireless protocol and a wireless interface unit for transmitting a second signal type corresponding to said standard over-the-air wireless protocol to a wireless communications carrier service and for receiving over-the-air data from said wireless communications carrier service which is convertible to instructions and conveyable to said security system; and
a computing device in communication with the wireless communications carrier service including a database table for converting said second signal type into a predefined signal format usable by an identified monitoring company and including a conveyance device for conveying said predefined signal format to said identified monitoring company.

2. A method of operating a wireless security system network comprising:
generating a first signal type based on a condition sensed by a security sensor,
converting said first signal type into a standard over-the-air wireless protocol,
transmitting a second signal type corresponding to said standard over-the-air wireless protocol to a wireless communications carrier service,
converting said second signal type into a predefined signal format usable by an identified monitoring company, and
conveying said predefined signal format to said identified monitoring company.
